(19) United States
(12) Patent Application Publication
(10) Pub. No.: US 2015/0120573 A1
(43) Pub. Date: Apr. 30, 2015

(54) INFORMATION PROCESSING METHOD, DEVICE AND SYSTEM

(71) Applicant: Tencent Technology (Shenzhen) Company Limited, Shenzhen (CN)

(72) Inventor: Dongming XIA, Shenzhen (CN)

(21) Appl. No.: 14/456,790

(22) Filed: Aug. 11, 2014

Related U.S. Application Data
(63) Continuation of application No. PCT/CN2014/078239, filed on May 23, 2014.

(30) Foreign Application Priority Data
Oct. 31, 2013 (CN) 201310530593.8

(51) Int. Cl. G06Q 20/38; G06Q 20/40; G06Q 20/20

(52) U.S. Cl. CPC G06Q 20/38215; G06Q 20/206; G06Q 20/40145
USPC 705/73

(57) ABSTRACT

The present application discloses methods, devices and systems for information processing, and in particular for financial transactions. In some embodiments, a check-out terminal acquires and decrypts an encrypted image displayed by or sent from a paying terminal associated with a user. The encrypted image encodes information such as account identifiers and a payment amount. Then, the check-out terminal sends a payment request to a server so that the server can respond with a message that prompts the user to provide verification information. In some embodiments, the prompting message is displayed by the check-out terminal and the verification information includes biometric information of the user. The verification information is transferred from the check-out terminal to the server to be used by the server to verify the payment request. If the verification is successful, the server generates processing results for the payment request and sends the results to the check-out terminal.

### RELATED APPLICATIONS

This application is a continuation application of PCT Patent Application No. PCT/CN2014/078239, entitled “INFORMATION PROCESSING METHOD, DEVICE AND SYSTEM” filed on May 23, 2014, which claims priority to Chinese Patent Application No. 201310530593.8, “Information Processing Method, Apparatus and System,” filed on Oct. 31, 2013, both of which are hereby incorporated by reference in their entirety.

### FIELD OF THE APPLICATION

The present application relates to the Internet technical field, especially relates to an information processing method, device and system.

### BACKGROUND OF THE APPLICATION

At present, many shopping sites support card payment. For example, consumers can swipe their credit card, debit card, pay card, or shopping card issued by the shopping site to pay for goods or services. The existing payment methods usually require payment through a Point of Sale (POS) terminal to swipe a magnetic stripe on the card. However, at present, the speed to swipe the magnetic stripe is slow. Moreover, in case the magnetic stripe on the card is damaged, the POS terminal may need a longer time to finish swiping card or be simply unable to recognize the card. Therefore, at present, the overall efficiency to process payment information is relatively low.

### SUMMARY

The above deficiencies and other problems associated with the existing technology are reduced or eliminated by the application disclosed below. In some embodiments, the application is implemented in a computer system that has one or more processors, memory and one or more modules, programs or sets of instructions stored in the memory for performing multiple functions. Instructions for performing these functions may be included in a computer program product configured for execution by one or more processors.

One aspect of the application involves a computer-implemented method for payment transfer using a check-out terminal. The check-out terminal may acquire an encrypted image displayed by a paying terminal associated with a user, wherein the encrypted image encrypts payment information including a payment amount and an identifier of a payment account associated with the paying terminal. After decrypting the encrypted image to acquire the payment information, the check-out terminal may send a payment request to a server, wherein the payment request includes the payment information. In response to a response from the server, the check-out terminal may display a message prompting the user to provide verification information, wherein the verification information comprises biometric information of the user. Then, the check-out terminal may transfer the verification information provided by the user to the server, wherein the server generates processing results for the payment request when the verification information authenticates the payment request; and the check-out terminal may receive and display the processing results returned from the server.

Another aspect of the application involves a check-out terminal. The check-out terminal comprises one or more processors; memory; and one or more programs modules stored in the memory and configured for execution by the one or more processors, the one or more program modules including: an acquiring module configured to acquire an encrypted image displayed by a paying terminal associated with a user and decrypt the encrypted image to acquire payment information, wherein the encrypted image encrypts the payment information including a payment amount and an identifier of a payment account associated with the paying terminal; a sending module configured to send a payment request to a server, wherein the payment request includes the payment information; a request verification module configured to display a message in response to a response from the server, the message prompting the user to provide verification information, wherein the verification information comprises biometric information of the user, a transfer module configured to transfer the verification information provided by the user to the server, wherein the server generates processing results for the payment request when the verification information authenticates the payment request; and a receiving module configured receive and display the processing results returned from the server.

Another aspect of the application involves a non-transitory computer readable storage medium having stored therein one or more instructions, which, when executed by a check-out terminal, cause the check-out terminal to: acquire an encrypted image displayed by a paying terminal associated with a user, wherein the encrypted image encrypts payment information including a payment amount and an identifier of a payment account associated with the paying terminal, decrypt the encrypted image to acquire the payment information; send a payment request to a server, wherein the payment request includes the payment information; in response to a response from the server, display a message prompting the user to provide verification information, wherein the verification information comprises biometric information of the user; transfer the verification information provided by the user to the server, wherein the server generates processing results for the payment request when the verification information authenticates the payment request; and receive and display the processing results returned from the server.

Some embodiments may be implemented on one or more computer devices in a network environment.

### BRIEF DESCRIPTION OF THE DRAWINGS

The aforementioned features and advantages of the application as well as additional features and advantages thereof will be more clearly understood hereinafter as a result of a detailed description of preferred embodiments when taken in conjunction with the drawings.

FIG. 1 is a schematic illustration of an information transmission method, showing how a check-out terminal and a server interact according to some embodiments of the present application;

FIG. 2 is a schematic illustration of an information transmission method, showing how a check-out terminal, a paying terminal, and a server interact according to some embodiments of the present application;

FIG. 3 is a flowchart illustrative of the information transmission method conducted by the check-out terminal according to some embodiments of the present application;

FIG. 4 is a flowchart illustrative of the information transmission method conducted by the paying terminal according to some embodiments of the present application;

FIGS. 5A-5D are exemplary screen shots of the paying terminal and/or the check-out terminal according to some embodiments of the present application;

FIG. 6 is a schematic diagram showing the structure of an information processing system according to some embodiments of the present application;

FIG. 7 is a schematic diagram showing the structure of another information processing system according to some embodiments of the present application;

FIG. 8 is a block diagram of an information processing device, such as a check-out terminal, according to some embodiments of the present application;

FIG. 9 is a block diagram of an information processing device, such as a paying terminal, according to some embodiments of the present application;

FIG. 10 is a schematic structural diagram of an information processing device, such as a check-out terminal, according to some embodiments of the present application;

FIG. 11 is a schematic structural diagram of an information processing device, such as a server, according to some embodiments of the present application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The encrypted images in the embodiment of the present application include but are not limited to: two-dimension codes and three-dimension codes, among which, two-dimension code may include stack type two-dimension code, line type two-dimension code, matrix two-dimension code, or PDF417 code, etc. The PDF417 code is a portable data file with high density and high information content; the PDF417 code may encrypt all information that can be digitized, such as texts, images, photos, fingerprint, palm print, signature, voice, etc.

In the embodiments of the present application, the check-out terminal may be any terminals that have basic computing and communication capabilities and can acquire payment information, such as by scanning encrypted images. For example, the check-out terminal may be tablet PCs, mobile phones, electronic readers, remote controls, personal computers (PC), notebook computers, vehicle computer units, network television, wearable devices or POS terminal and other smart devices. The paying terminal may be any terminals that have basic computing and communication capabilities and can send or display payment information, such as by displaying encrypted images that encode the payment information. For example, the paying terminal may be tablet PC, mobile phones, electronic readers, remote control, PC, notebook computer, vehicle computer units, network televisions, wearable devices or POS terminal, or other smart devices. The server according to some embodiments of the present application may be any computing device that have computing and network capabilities.

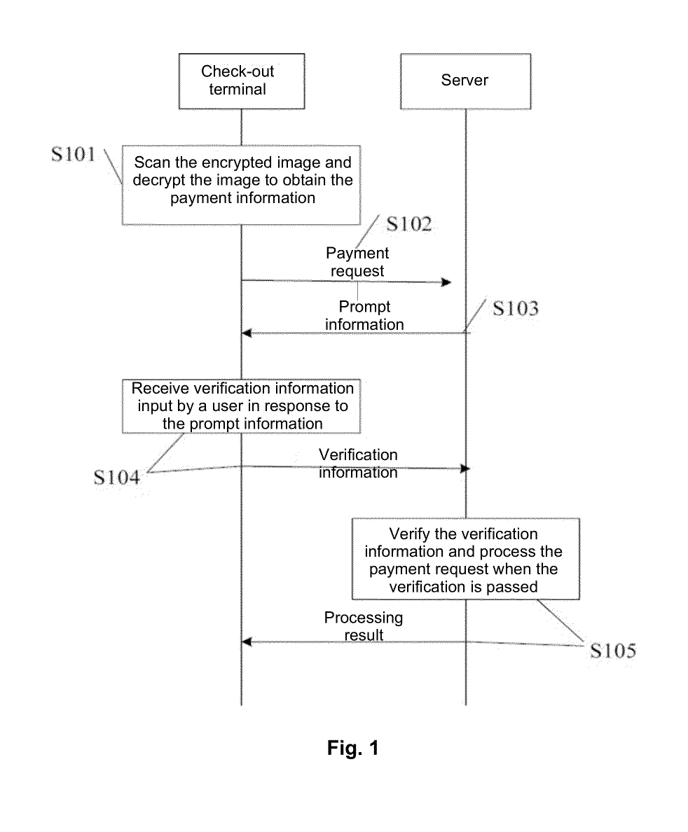

FIG. 1 is a schematic illustration of an information transmission method, showing how a check-out terminal and a server interact according to some embodiments of the present application. As shown in FIG. 1, the method may include the following steps:

S101, the check-out terminal acquires an encrypted image that encodes payment information, and the check-out terminal decrypts the encrypted image to acquire the payment information.

S102, the check-out terminal sends the payment request including the payment information to a server, e.g. a payment platform server. In some embodiments, the payment information includes the payment information. For example, the payment request includes a payment account identifier and a payment amount so that the server may identify the payment account associated with the paying terminal. If all verifications are successful, the server conducts a financial transaction according to the information provided by the payment request.

S103, the server sends prompt information to the check-out terminal according to the payment request; the prompt information is used to prompt the user of the paying terminal to enter verification information at the check-out terminal.

In some embodiments, the server, e.g. the payment platform server, may send the prompt information to the check-out terminal after it receives the aforementioned payment request, so as to prompt the check-out terminal to receive the verification information input and transfer the verification information to the server.

S104, the check-out terminal receives the verification information input by the user in response to the prompt information, and then the check-out terminal transfers the verification information to the server.

In some embodiments, the check-out terminal may display the prompt information after it receives the prompt information. The user may respond to the prompt information and input verification information. In some embodiments, the verification information may be specifically requested and used by the server to verify whether the user is authorized to request the financial transaction included in the payment request. For example, the verification information may include password, expiration date, card identifier, and biometric information of the user.

S105, the server verifies the verification information. When the verification passes, the server processes the payment request and the server sends the processing results of the payment request to the check-out terminal.

In some embodiments, the server may authenticate the payment request by comparing the verification information sent by the check-out terminal with the verification information of the payment account obtained by the server in advance, e.g. during a registration process. If the comparison shows consistency, the verification is successful.

The server may be a banking server, or the server may be the server associated with the check-out terminal by default. For example, when the check-out terminal is a check-out terminal of a certain shopping center and the payment account is the payment account issued by this shopping center, the server may be the server of this shopping center.

In some embodiments, through the aforementioned steps, when the payer goes shopping in the payee's store, or the payer user and payee user request a financial transaction, the payer user only needs to control a device to display the encrypted image, the payee user only needs to control the check-out terminal to scan this encrypted image and then it may finish the payment operation or financial transaction.

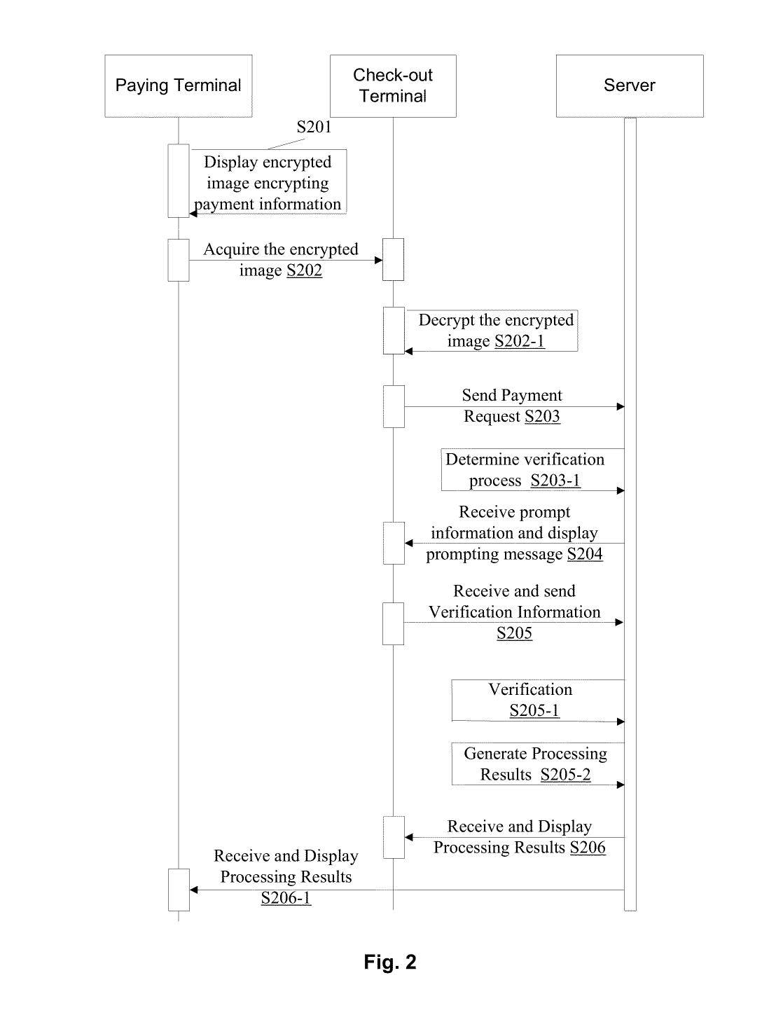

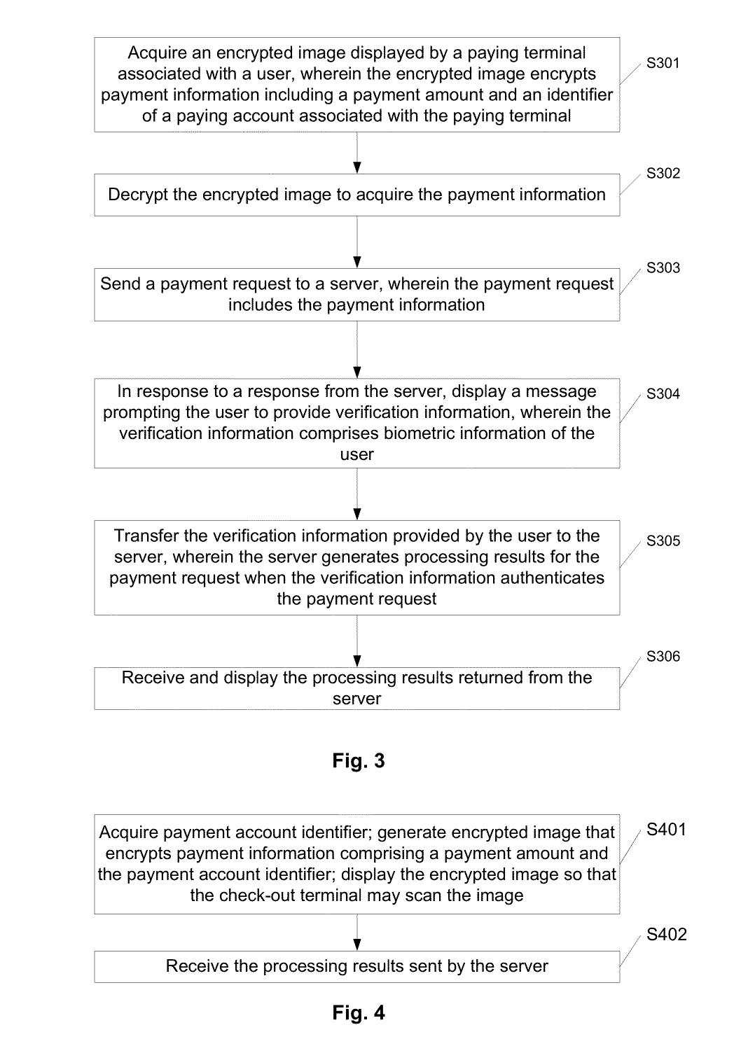

FIG. 2 is a schematic illustration of an information transmission method, showing how a check-out terminal, a paying terminal, and a server interact according to some embodiments of the present application. FIG. 3 is a flowchart illustrative of the information transmission method conducted by the check-out terminal according to some embodiments of the present application.

As shown in FIG. 2, the method may include the following steps:

S201, the paying terminal displays an encrypted image, which encrypts payment information. The payment information may include a number of information items, such as but not limited to any one or a combination of: a payment amount, a paying terminal identifier, a payment account identifier, a check-out terminal identifier, a selling account identifier, and information related to the merchandise or service to be purchased, such as an item number or a description of the merchandise and the service. The identifiers may be used to identify the accounts and terminals so that proper operations can be conducted according to the identifications. In some embodiments, the payment information includes a payment amount and information related to a payment account, e.g. a payment account identifier such as an account number or account user's name that may be used to identify the payment account. In some embodiments, the payment account is associated with the paying terminal or the payment account is associated with a communication account installed on the paying terminal. The communication account can be an account in a program, such as a social networking program, installed on the paying terminal. In some embodiments, the payment information includes the payment account identifier but not the payment amount.

In some embodiments, the encrypted image may be any graphic display. For example, the encrypted image may be an image of a payment card, e.g. a credit card, debit card, or shopping card. In some embodiments, the encrypted image is a 2-D or 3-D code that is generated based on the payment information. The encrypted image may be displayed by the paying terminal so that the check-out terminal can acquire the encrypted image by scanning or image capturing. Alternatively, the encrypted image may be sent by the paying terminal to the check-out terminal through communication channels such as emails, instant messages, and other file transfer technologies.

The encrypted image is generated based on the payment information. Referring to step S401 of FIG. 4, in some embodiments, the paying terminal acquires payment account identifier, generates the encrypted image that encrypts payment information comprising a payment amount and the payment account identifier, and displays the encrypted image so that the check-out terminal may scan the image.

The payment information or part of the payment information may be acquired through user input. For example, the user enters the payment amount, the payment account identifier, and a merchandise identifier, such as an item number through the paying terminal. In some embodiments, the user may also enter a command to the paying terminal to request a financial transaction. Such information is gathered and processed by the paying terminal to generate the encrypted image. Alternatively, the payment information or part of the payment information may be acquired through automated means. For example, the merchandise to be purchased may bear a code that can be scanned or acquired by the paying terminal so that the paying terminal may decrypt the code to get information such as the price of the merchandise and a description of the merchandise. The paying terminal can then use information resulted from scanning the code as all or part of the payment information to generate the encrypted image. In some embodiments, the process of acquiring the payment information can be controlled by a communication program installed in the paying terminal. In some embodiments, the user account of the communication program is bound to the paying terminal and the functions associated with the communication program may be used to acquire the payment information and to generate the encrypted image.

As indicated, the information gathered by the paying terminal can be used by the paying terminal to generate the encrypted image. Alternatively, in some embodiments, the information can be sent by the paying terminal to a server so that the server may generate the encrypted image and transfer the encrypted image back to the paying terminal. Such an approach may lower the computational burden on the paying terminal. In addition, such an approach may improve security because in some cases the paying terminal may not be fully informed as to how the encryption process is conducted.

S202, the check-out terminal acquires the encrypted image. In particular, also referring to FIG. 3, step S301, the check-out terminal may acquire an encrypted image displayed by the paying terminal associated with a user, wherein the encrypted image encrypts payment information including a payment amount and an identifier of a payment account associated with the paying terminal.

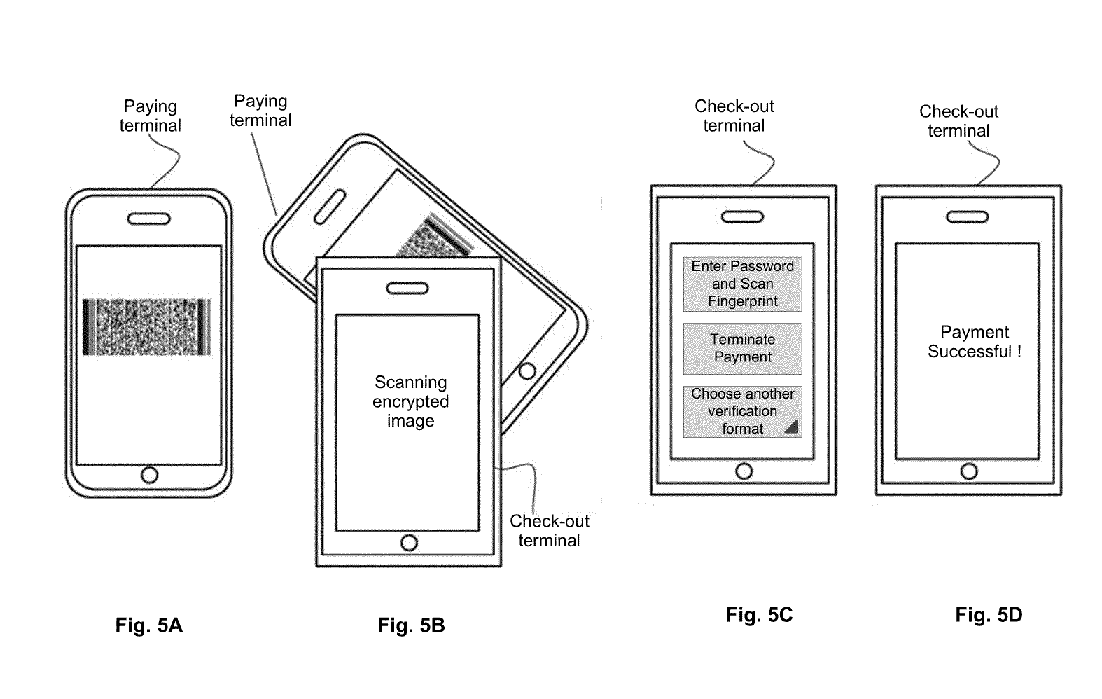

Referring to FIGS. 5A and 5B, which provide sampling screen shots for the paying terminal and the check-out terminal. FIG. 5A shows the paying terminal displaying an encrypted image that encodes payment information. FIG. 5B shows the check-out terminal scanning the encrypted image displayed by the paying terminal.

In some embodiments, the payment information encrypted by the encrypted image does not include the payment amount, which is provided by the check-out terminal, not the paying terminal. the payment amount may also be preset by the check-out terminal, for example, all the payment amounts included in the payment request sent by the check-out terminal are fixed.

The user is a user associated with the paying terminal. For example, when the paying terminal is a smart phone with a phone number, the user may be the owner of the smart phone and the phone number. In some embodiments, the user already has registered accounts, such as accounts in communication programs, bound to the paying terminal. When someone else is trying to initiate an illegitimate transaction, the person is not a legitimate user who is authorized to complete the transaction. Subsequent verifications are sometimes needed when the server is set up to determine whether the user is a legitimate user. In some embodiments, the way to determine the legitimate user is to verify the identity of the user. In some embodiments, the way to verify the identity is through biometric information.

S202-1: the check-out terminal decrypts the encrypted image. In particular, referring to S302 of FIG. 3, the check-out terminal decrypts the encrypted image to acquire the payment information.

S203: the check-out terminal sends a payment request to the server. In particular, referring to S303 of FIG. 3, the check-out terminal sends a payment request to a server, wherein the payment request includes the payment information.

In some embodiments, the payment information includes the payment amount. In some embodiments, the payment information does not include the payment amount. In such cases, the check-out terminal may add the payment amount into the payment request besides the payment information. Alternatively, the payment amount can be sent to the server through a separate communication. In some embodiments, the payment request does not include the entire contents of the payment information. In some embodiments, the payment request includes other information items besides the payment information, whether or not the payment amount is included. Depending on what information items are included in the payment information, the check-out terminal may adjust the contents of the payment request so that the server gets sufficient information to process the payment request. In some embodiments, the payment request includes information such as but not limited to: identifiers that can be used to identify the accounts and terminals, information related to the merchandise or service to be purchased such as a brief description, price and payment amount, which in most cases are the same, and a specific request as to how the server should transfer the funds. In some embodiments, the payment request also includes instructions regarding how the server should verify the payment request. Such instructions may direct the server to acquire user information, such as biometric information.

In some embodiments, the server identifies the accounts, e.g. payment account and selling account, by identifying the terminals, e.g. paying terminal and check-out terminal. For example, the payment request includes a paying terminal identifier and a check-out terminal identifier that allow the server to identify which terminals are involved in the transaction. Since in some cases the payment account is bound to the paying terminal and the check-out terminal account is bound to the check-out terminal, the payment account and the selling account are identified if the relationship information between the accounts and the terminals has been provided to the server. Alternatively, the payment request includes identifiers specifically for the payment account and the selling account.

S203-1: the server determines the verification process. The server may have a default set up as to how the verification should be handled regarding specific check-out terminal or all check-out terminals and regarding specific or all payment requests. Alternatively, the payment request includes instructions as to how the verification process should be conducted, and the server follows the instruction entirely or in part. The server may determine whether verification is needed and what kind of verification information should be requested. For example, when the payment amount is small, e.g. less than a preset value, the server determines that additional verification is not necessary and proceeds directly to process the payment request and generate processing results. Alternatively, when the payment amount is less than a preset value, the server determines that only certain kinds of verification information, e.g. account verification information such as account number and password, while other kinds of verification information, e.g. identity verification information such as biometric information, is not needed. In some embodiments, when the payment amount is greater than a preset value, the server determines that verification information is needed. In some embodiments, when the payment amount is greater than a preset value, the server determines that certain kinds of verification information, e.g. biometric information, is needed in addition to or instead of other kinds of verification information, e.g. password.

In some embodiments, the verification process can be a tiered approach—different verification information can be requested corresponding to different amount of payment or different levels of security requirements. For example, when the payment amount is less than a first preset value, the server only requests a password through the check-out terminal; when the payment amount is more than the first preset value but less than a second preset value, the server requests fingerprint or voice information through the check-out terminal; when the payment amount is more than the second preset value, the server requests fingerprint and voice information through the check-out terminal. It should also be noted that the specific verification information requested in accordance with specific tier of payment amount or security level may vary.

S204, the check-out terminal receives prompt information from the server and displays a prompting message, wherein the prompt information is generated according to the payment request and the prompt information is used to generate the prompting message. The prompting message is displayed by the check-out terminal.

In some embodiments, the prompt information provides instructions to the check-out terminal as to what kind of verification information should be requested from the user and what kind of prompting message should be presented to the user. The prompt information can be displayed directly by the check-out terminal. Alternatively, the check-out terminal can process the prompt information and generate a message to prompt the user to provide verification information. The check-out terminal may generate the message based on preset rules and the prompt information. For example, the prompt information instructs the check-out terminal to acquire biometric information from the user; the check-out terminal can determine, based on preset rules and the acquiring capabilities of the check-out terminal, as to what kind of biometric information should be requested. For example, the check-out terminal may determine that the user should present his/her fingerprint so that the check-out terminal can scan the fingerprint and send to the server. The prompt information may also be determined by the server based on what kind of information has already been entered by the user during a registration process. For example, when the server has already saved voice print information from the user, the prompt information can instruct the check-out terminal to collect voice signals from the user so that the collected voice signals can be processed and the resulting voice print can be compared with the saved voice print for verification. In some embodiments, the prompt information instructs the check-out terminal to allow the user to choose among a number of verification formats or combinations. For example, the check-out terminal may request the user to enter both a password and a voice signal.

Referring to S304 of FIG. 3, in some embodiments, in response to prompt information from the server, the check-out terminal displays a message prompting the user to provide verification information, wherein the verification information comprises biometric information of the user. The biometric information can be information related to biometrics such as but not limited to: finger print, iris, face features, voice print, nucleotides such as DNA, palm print, hand geometry, retina, and odor/scent. In some embodiments, the biometric information can be acquired by scanning a body part of the user. The body part may be selected from: finger prints, iris, face features, palm, hand, and retina.

In addition to prompting the user to enter the verification information, the check-out terminal may also display other options that allow the user to take alternative actions, such as but not limited to: terminating the transaction without verification, changing the payment information by re-submission, and choosing other verification formats. The specific display may be determined by the check-out terminal and the prompt information from the server.

Referring to FIG. 5C, which is a screen shot of the check-out terminal showing the message prompting the user to provide verification information. In FIG. 5C, the check-out terminal displays three buttons: “enter password and scan finger print,” “terminate payment,” and “choose another verification format.” It should be noted that the display shown in FIG. 5C serves as examples of variable designs. However, the three buttons illustrate the categories of actions that can be taken by the user. The check-out terminal requests the user to enter verification information, which can vary based on the prompt information from the server and certain preset rules of the check-out terminal. In some embodiments, the check-out terminal requests the user to enter only non-biometric information, such as a password; in some embodiments, the check-out terminal requests the user to enter only the biometric information, such as finger print or voice signal; in some embodiments, the check-out terminal requests the user to enter both non-biometric and biometric information. In some embodiments, as indicated above, the prompting message may also allow the user to terminate the transaction without going through the verification process. In some embodiments, the prompting message may allow the user to choose other formats of verification. The triangle in the “choose another verification format” button indicates that a drop-down menu may list the other verification formats that the user may choose. For example, while the user is asked to enter password and finger print here, he/she may also be allowed to enter password and voice signal instead.

S205, the check-out terminal receives the verification information input by the user in response to the prompting message, and then the check-out terminal sends the verification information to the server. Also referring to S305 of FIG. 4, the check-out terminal transfers the verification information provided by the user to the server, wherein the server generates processing results for the payment request when the verification information authenticates the payment request.

In some embodiments, the check-out terminal transfers the verification information input from the user without further processing. For example, the check-out terminal records voice signals input by the user, e.g. by speaking into a microphone associated with the check-out terminal, and sends the voice signal directly to the server. In some embodiments, the check-out terminal processes the verification information input from the user and sends the processed information to the server. For example, the check-out terminal records the voice signals from the user and extracts voice print from the voice signals; then the check-out terminal sends the voice print information to the server.

S205-1 and S205-2: the server verifies the verification information; when the verification is successful, the server processes the payment request and generates processing results.

The server receives the verification information from the check-out terminal and verifies the verification information. In some embodiments, the server compares the verification information received from the check-out terminal with saved information from the user during a prior registration process, wherein the saved information is considered authentic and the user is determined to be authorized to access the payment account. If the comparison shows consistency, the verification is successful. If the comparison shows inconsistency, the verification is unsuccessful and the payment request is authenticated. If the verification is unsuccessful, the payment request is not authenticated and the user is determined to be not authorized to access the payment account. When the verification is unsuccessful, the processing results are generated without further inquiry of the payment request and the processing results indicate that the transaction cannot be completed.

The processing results of the payment request may include an approval or a denial. When the verification is not successful, the processing results include a denial; when the verification is successful, the processing results are based on other factors related to the payment request. For example, the processing results include an approval when the payment account contains an equal or greater amount of fund compared with the payment amount. On the other hand, the processing results include a denial when the server determines that the payment account contains a lesser amount compared with the payment amount.

The processing results may also include other information in addition to the approval or denial. In some embodiments, the processing results include a message that can be displayed by the check-out terminal and/or paying terminal. In some embodiments, the message informs the user as to how to continue or abort the requested transaction. For example, when the processing results include an approval, the message may inform the user that the verification is successful and the transaction has been completed. In such a manner the seller, e.g. the party operating the check-out terminal, can deliver the merchandise or service to the user payer. On the other hand, when the processing result include a denial, the message may inform the user payer and the party operating the check-out terminal that the verification is not successful or the payment account does not include sufficient funds. In essence, when the processing results include a denial, the processing results may include additional information explaining why the transaction cannot be completed so that the user may take corresponding actions.

In some embodiments, the processing results may also include options to the user as to what additional actions can be taken. For example, when the processing results include a denial, the message to be displayed by the check-out terminal or paying terminal may allow the user to: re-submit the payment request, re-submit the verification information, or cancel the transaction. The processing results may also include instructions to the check-out terminal as to what actions can be taken. In some embodiments, the processing results instruct the check-out terminal to terminate the transaction without giving the user additional opportunity to revise the payment information or verification information. In some embodiments, the processing results instruct the check-out terminal to display options to allow the user to make revisions and re-submissions.

S206: the server sends the processing results of the payment request to the check-out terminal. Also referring to S306 of FIG. 3, the check-out terminal receives and displays the processing results returned from the server. Also referring to FIG. 5D, which shows the check-out terminal displaying a “payment successful” message when the

The processing results may include an approval or denial and other information that may allow the user payer to take appropriate actions. The processing results may also provide instructions to the check-out terminal as to what actions can be taken by the check-out terminal and/or what actions should the check-out terminal allow the user of the paying terminal to take.

S206-1: the server sends the processing results to the paying terminal. Also referring to S402 of FIG. 4, the paying terminal receives the processing results from the server. The processing results may include an approval or denial and other information that may or may not allow the user to take additional actions.

In some embodiments, the server that processes the payment request may also complete the transaction according to the payment request if the verification is successful. In some embodiments, the server transfers the payment amount in the payment account to a selling account associated with the check-out terminal. Alternatively, the server that processes the payment request communicates with another device, e.g. a bank server, to complete the transaction. In some embodiments, the server that processes the payment request and the bank server may be considered a single device connected with operable networks.

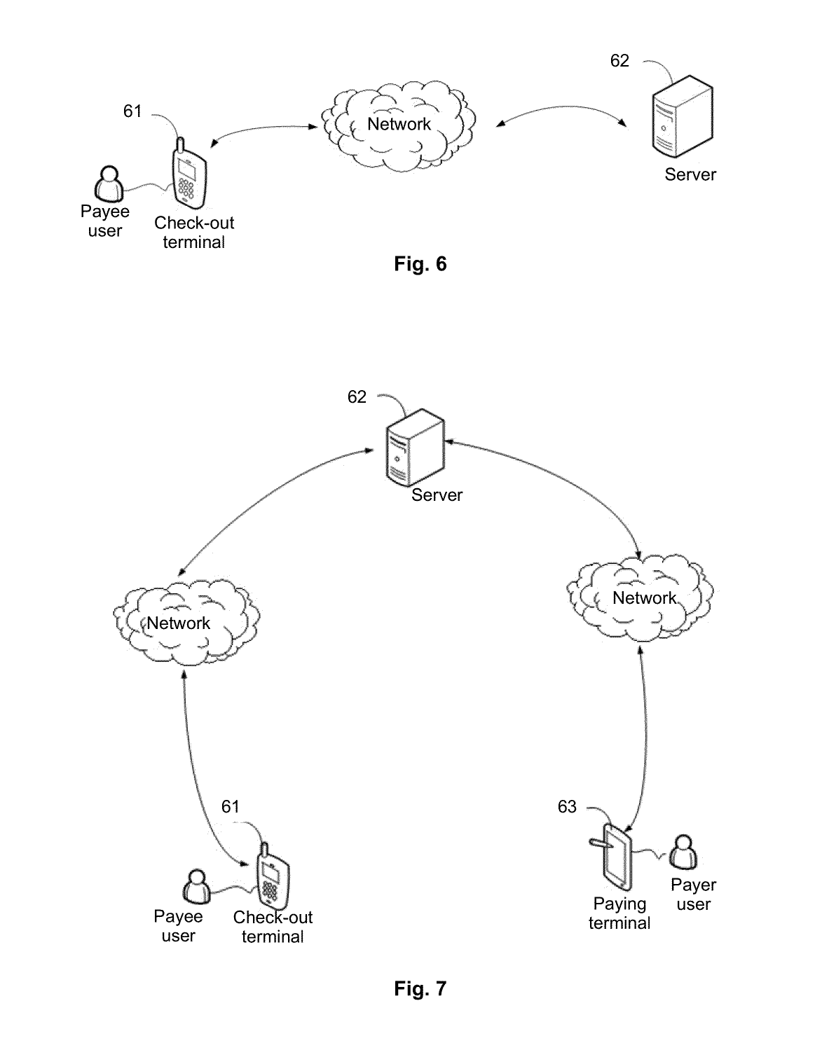

FIGS. 6-11 illustrate the devices and systems that may be used to perform the methods described above. To avoid redundancy, not all the details and variations described for the method are herein included for the devices and systems. The details and variations provided for the methods should be considered included for the description of the devices and systems as long as they are not in direct contradiction to the specific description provided for the devices and systems.

FIG. 6 is a schematic diagram showing the structure of an information processing system according to some embodiments of the present application. As shown in FIG. 6, the information processing system may include a check-out terminal 61 and server 62, wherein the check-out terminal 61 is associated with a payee user.

The check-out terminal 61 is configured to scan or receive an encrypted image encrypting payment information, wherein the payment information comprises a payment account identifier. The check-out terminal 61 is also configured to decrypt the encrypted image to acquire the payment information and send a payment request including the payment information to the server 62. In some embodiments, the payment request comprises a payment amount.

The server 62 is configured to send prompt information to the check-out terminal 61 in response to the payment request and based on the payment request, wherein the prompt information is used by the check-out terminal 61 to generate prompting message to request a user of a paying terminal to enter verification information.

In some embodiments, the server 62 may send the prompt information to the check-out terminal 61 when certain conditions are satisfied. For example, the prompt information can be sent when the payment amount is greater than a preset value.

The check-out terminal 61 is further configured to display a prompting message in response to the prompt information sent from the server 62. After the user enters verification information input, the check-out terminal 61 is configured to receive the verification information input by the user and then send the verification information to the server 62.

The verification information may be information the server 62 needs to verify the payment request. In some embodiments, the verification information may be a password, expiration date, or card identifier of the payment account. In some embodiments, the verification information is biometric information, which can be information related to any or a combination of: fingerprint, iris, face features, voice print, nucleotides such as DNA, palm print, hand geometry, retina, and odor/scent. In some embodiments, the biometric information is acquired by scanning a body part of the user.

The server 62 is further configured to verify the verification information. When the verification is successful, the server 62 processes the payment request and sends the processing results of the payment request to the check-out terminal 61.

In some embodiments, the server 62 verifies the verification information by comparing the verification information sent by the check-out terminal and saved information that has been authenticated. The saved information may have been obtained by the server 62 in a prior registration. If the comparison shows consistency, the verification is successful.

In some embodiments, the server 62 is further configured to complete the transaction according to the payment request when the verification is successful. For example, the server 62 may transfer the payment amount from the payment account associated with the paying terminal to the selling account associated with the check-out terminal 61.

In some embodiments, the server 62 may be a banking server, or the server 62 may be a platform server running a program, e.g., communication software, installed in the check-out terminal 61 and/or a paying terminal. In some embodiments, when the check-out terminal 61 is a check-out terminal 61 of a certain shopping center and the payment account is a payment account issued by this shopping center, the server 62 may be the server of this shopping center.

FIG. 7 is a schematic diagram showing the structure of another information processing system according to some embodiments of the present application. The information processing system may include a check-out terminal 61, a server 62, and a paying terminal 63.

The check-out terminal 61 is configured to scan or receive an encrypted image displayed by or sent from the paying terminal 63, wherein the encrypted image encrypts payment information including a payment amount and an identifier of a payment account associated with the paying terminal. The check-out terminal 61 is configured to decrypt the encrypted image to acquire the payment information. In some embodiments, the payment information includes a payment amount.

The check-out terminal 61 is configured to send a payment request to the server 62 after acquiring the payment information, wherein the payment request includes part or all of the payment information.

The server 62 may be configured to determine whether verification is needed and what kind of verification information should be requested. For example, when the payment amount is small, e.g. less than a preset value, the server 62 determines that additional verification is not necessary and proceeds directly to process the payment request and generate processing results. Alternatively, when the payment amount is less than a preset value, the server determines that only certain kinds of verification information, e.g. password, while other kinds of verification information, e.g. biometric information, is not needed. In some embodiments, when the payment amount is greater than a preset value, the server 62 determines that verification information is needed. In some embodiments, when the payment amount is greater than a preset value, the server determines that certain kinds of verification information, e.g. biometric information, is needed in addition to or instead of other kinds of verification information, e.g. password.

The server 62 is configured to send prompt information to the check-out terminal 61 in response to the payment request and based on the payment request, wherein the prompt information is used by the check-out terminal 61 to generate prompting message to request a user of a paying terminal to enter verification information.

In some embodiments, the server 62 may send the prompt information to the check-out terminal 61 when certain conditions are satisfied. For example, the prompt information can be sent when the payment amount is greater than a preset value.

The check-out terminal 61 is further configured to display a prompting message in response to the prompt information sent from the server 62. After the user enters verification information input, the check-out terminal 61 is configured to receive the verification information input by the user and then send the verification information to the server 62.

The verification information may be information the server 62 needs to verify the payment request. In some embodiments, the verification information may be a password, expiration date, or card identifier of the payment account. In some embodiments, the verification information is biometric information, which can be information related to any or a combination of: finger print, iris, face features, voice print, nucleotides such as DNA, palm print, hand geometry, retina, and odor/scent. In some embodiments, the biometric information is acquired by scanning a body part of the user.

Server 62 is also configured to verify the verification information. In some embodiments, the server 62 processes the payment request when the verification is successful.

The server 62 may verify the verification information by comparing the verification information sent by the check-out terminal 61 with saved information that has been obtained in advance and authenticated. If the comparison shows consistency, the verification is successful.

In some embodiments, the verification information can specifically include at least one of the following: fingerprint information, face information, retina or iris information, or voiceprint information.

The check-out terminal 61 may scan the fingerprint of the user and obtains the fingerprint information. Scanning the fingerprint and obtaining the fingerprint information can be conducted using a fingerprint sensor.

The check-out terminal 61 may scan the retina or iris of the user to obtain the retina or iris information. The retina or iris information can be obtained with a camera.

The check-out terminal 61 may scan the face and obtain the face information. The face information can be obtained with a camera.

The check-out terminal 61 may record the voice of the user to obtain voice print information.

Alternatively, the verification information, e.g. the biometric information, can be obtained by the paying terminal and transferred to the check-out terminal.

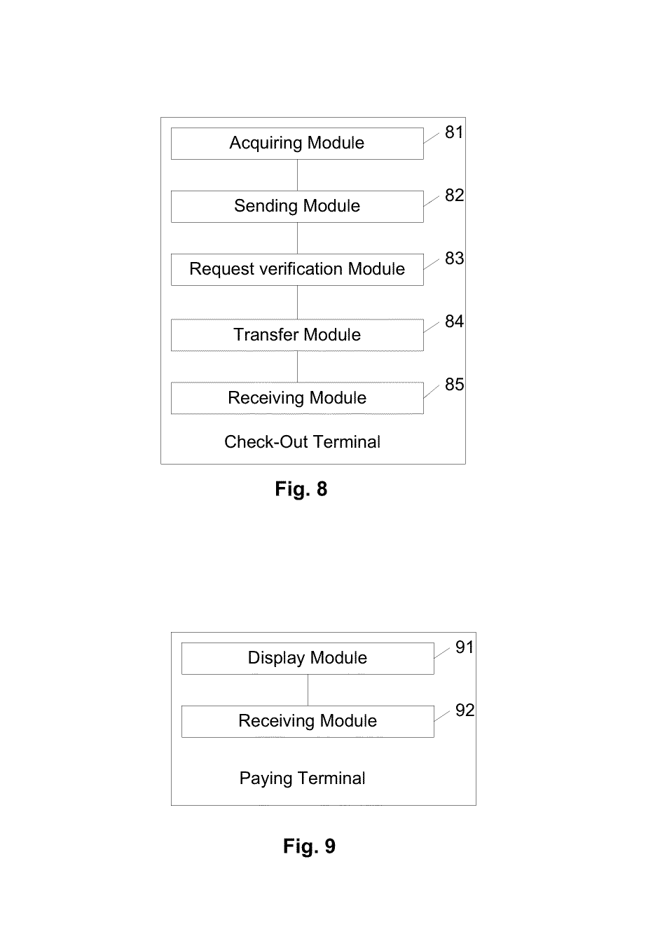

FIG. 8 is a block diagram of an information processing device, such as a check-out terminal, according to some embodiments of the present application. As shown in FIG. 8, the check-out terminal may comprise: an acquiring module 81, a sending module 82, a request verification module 83, a transfer module 84, and a receiving module 85.

The acquiring module 81 is configured to acquire an encrypted image displayed by a paying terminal associated with a user and decrypt the encrypted image to acquire payment information. In some embodiments, the encrypted image encrypts the payment information including a payment amount and an identifier of a payment account associated with the paying terminal.

The sending module 82 is configured to send a payment request to a server, wherein the payment request includes the payment information.

The request verification module 83 is configured to display a message in response to a response from the server, the message prompting the user to provide verification information. In some embodiments, the verification information comprises biometric information of the user.

The transfer module 84 is configured to transfer the verification information provided by the user to the server, wherein the server generates processing results for the payment request when the verification information authenticates the payment request.

The receiving module 85 is configured to receive and display the processing results returned from the server.

FIG. 9 is a block diagram of an information processing device, such as a paying terminal, according to some embodiments of the present application. As shown in FIG. 9, the paying terminal may comprise a display module 91 and a receiving module 92.

The display module 91 is configured to generate the encrypted image display the encrypted image so that the check-out terminal can scan the image.

The receiving module 92 is configured to receive the processing results of the payment request sent by the server.

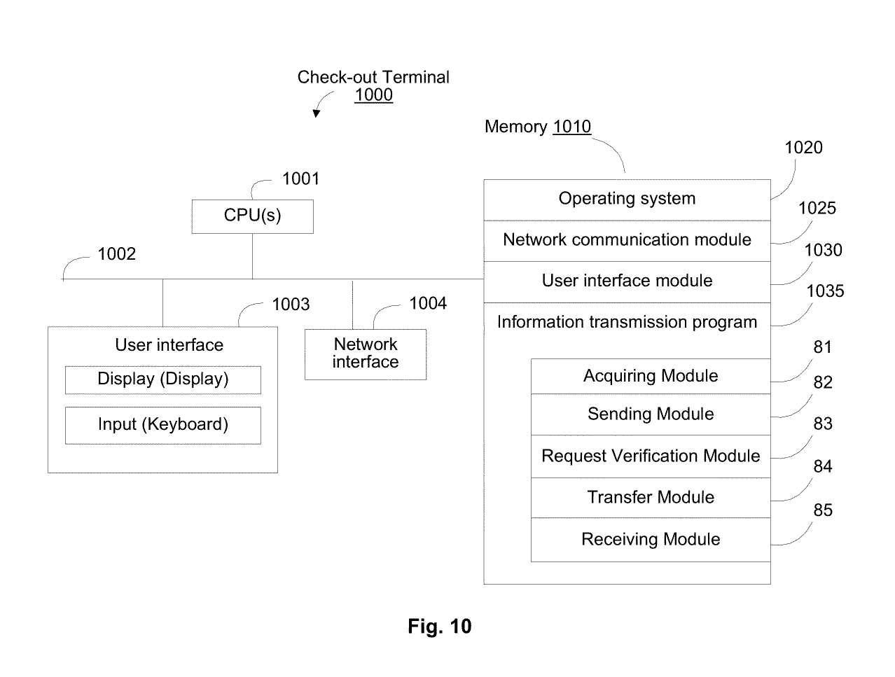

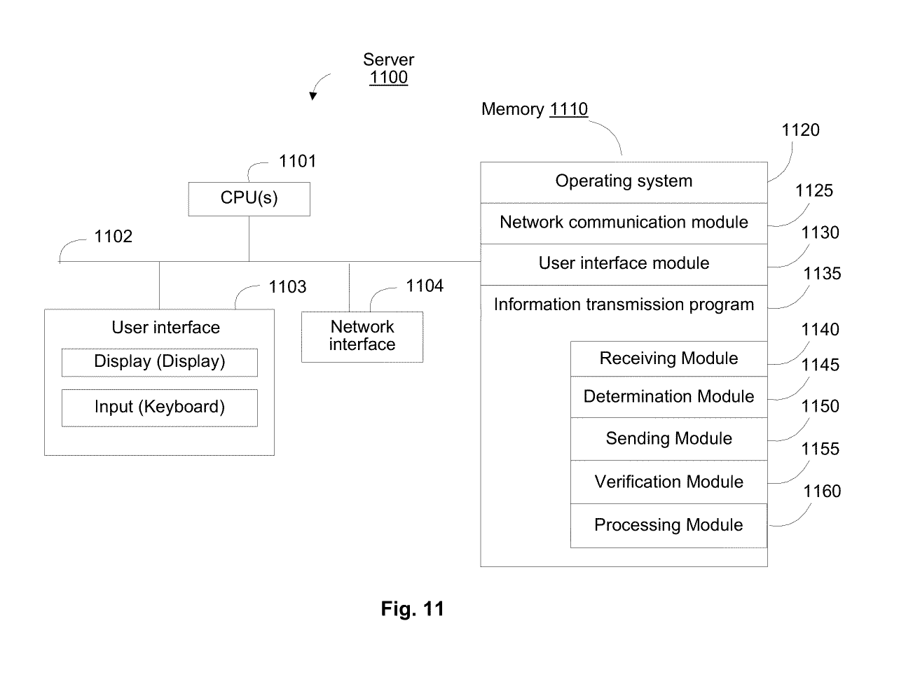

FIG. 10 is a schematic structural diagram of an information processing device, such as a check-out terminal, according to some embodiments of the present application;

As shown in FIG. 10, the exemplary check-out terminal 1000 typically includes one or more processing units (CPU's) 1001, one or more network or other communications interfaces 1004, memory 1010, and one or more communication buses 1002 for interconnecting these components. The communication buses 1002 may include circuitry (sometimes called a chipset) that interconnects and controls communications between system components. The user interface 1003 may include a touch screen, or a display and a keyboard. In some embodiments, the user interface 1003 may further include a standard wired interface and wireless interface, e.g. a Wi-Fi interface. Memory 1010 may include high speed random access memory and may also include non-volatile memory, such as one or more magnetic disk storage devices. Memory 1010 may include mass storage that is remotely located from the CPU's 1001. In some embodiments, memory 1010 stores the following programs, modules and data structures, or a subset or superset thereof:
an operating system 1020 that includes procedures for handling various basic system services and for performing hardware dependent tasks;
a network communication module 1025 that is used for connecting the check-out terminal 1000 to the server and/or other computers via one or more communication networks (wired or wireless), such as the Internet, other wide area networks, local area networks, metropolitan area networks, and so on;
a user interface module 1030 configured to receive user inputs through the user interface 1003;
and one or more information transmission programs 1035 including a number of terminal-side application modules such as the following:
an acquiring module 81 configured to acquire an encrypted image displayed by a paying terminal associated with a user and decrypt the encrypted image to acquire payment information
a sending module 82 configured to send a payment request to a server, wherein the payment request includes the payment information;
a request verification module 83 configured to display a message in response to a response from the server, the message prompting the user to provide verification information. In some embodiments, the verification information comprises biometric information of the user;
a transfer module 84 configured to transfer the verification information provided by the user to the server, wherein the server generates processing results for the payment request when the verification information authenticates the payment request; and
a receiving module 85 configured to receive and display the processing results returned from the server.

In the information transmission device 1000 shown in FIG. 10, the network interface 1004 is mainly used to connect to and conduct data communication with other devices; while processor 1001 is used to the run information processing programs stored in memory 1005.

FIG. 11 is a schematic structural diagram of an information processing device, such as a server, according to some embodiments of the present application.

As shown in FIG. 11, the exemplary server 1100 typically includes one or more processing units (CPU's) 1101, one or more network or other communications interfaces 1104, memory 1110, and one or more communication buses 1102 for interconnecting these components. The communication buses 1102 may include circuitry (sometimes called a chipset) that interconnects and controls communications between system components. The user interface 1103 may include a touch screen, or a display and a keyboard. In some embodiments, the user interface 1103 may further include a standard wired interface and wireless interface, e.g. a Wi-Fi interface. Memory 1110 may include high speed random access memory and may also include non-volatile memory, such as one or more magnetic disk storage devices. Memory 1110 may include mass storage that is remotely located from the CPU's 1101. In some embodiments, memory 1110 stores the following programs, modules and data structures, or a subset or superset thereof:
an operating system 1120 that includes procedures for handling various basic system services and for performing hardware dependent tasks;
a network communication module 1125 that is used for connecting the server 1100 to the check-out terminal and/or other computers via one or more communication networks (wired or wireless), such as the Internet, other wide area networks, local area networks, metropolitan area networks, and so on;
a user interface module 1130 configured to receive user inputs through the user interface 1103;
and one or more information transmission programs 1135 including a number of terminal-side application modules such as the following:
a receiving module 1140 configured to receive a payment request from the check-out terminal;
a determination module 1145 configured to determine what kinds of verification information should be requested based on the payment request;
a sending module 1150 configured to send prompt information to the check-out terminal so that the check-out terminal can display a prompting message to request the user to enter verification information;
a verification module configured to verify the verification information from the check-out terminal; and
a processing module configured to process the payment request and generate processing results when the verification is successful.

The terminology used in the description of the application herein is for the purpose of describing particular embodiments only and is not intended to be limiting of the application. As used in the description of the application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the application to the precise forms disclosed. Many modifications and variations are possible in view of the above teachings. The embodiments were chosen and described in order to best explain the principles of the application and its practical applications, to thereby enable others skilled in the art to best utilize the application and various embodiments with various modifications as are suited to the particular use contemplated.

What is claimed is:

1. A method for payment transfer using a check-out terminal, the method comprising:
at the check-out terminal having one or more processors and memory storing programs executed by the one or more processors,
acquiring an encrypted image displayed by a paying terminal associated with a user, wherein the encrypted image encrypts payment information including a payment amount and an identifier of a payment account associated with the paying terminal, decrypting the encrypted image to acquire the payment information;
sending a payment request to a server, wherein the payment request includes the payment information;
in response to a response from the server, displaying a message prompting the user to provide verification information, wherein the verification information comprises biometric information of the user;
transferring the verification information provided by the user to the server, wherein the server generates processing results for the payment request when the verification information authenticates the payment request; and
receiving and displaying the processing results returned from the server.

2. The method of claim 1, wherein:
the encrypted image is generated by the paying terminal.

3. The method of claim 1, wherein:
the encrypted image is generated by the server and transferred to the paying terminal to be displayed.

4. The method of claim 1, wherein:
the payment request is authenticated when the server determines that the user is authorized to access the payment account based on the biometric information.

5. The method of claim 1, wherein the biometric information is information related to:
fingerprint, iris, face features, voice print, DNA, palm print, hand geometry, retina, or odor/scent.

6. The method of claim 1, wherein:
the biometric information is acquired by scanning a body part of the user, and the body part is selected from the group consisting of: fingerprint, iris, retina, and face.

7. The method of claim 1, wherein:
the processing results include an approval or a denial; and
the processing results include an approval when the server determines that the payment account contains an equal or greater amount of fund compared with the payment amount.

8. The method of claim 7, wherein:
the server transfers the payment amount from the payment account to a selling account associated with the check-out terminal when the processing results include an approval.

9. The method of claim 1, wherein:
the processing results include an approval or a denial; and
the processing results include a denial when the server determines that the payment account contains a lesser amount compared with the payment amount, or when the server determines that the user is not authorized to access the payment account.

10. The method of claim 1, wherein:
the encrypted image is based on PDF417 code format.

11. A check-out terminal, comprising:
one or more processors;
memory; and
one or more programs modules stored in the memory and configured for execution by the one or more processors, the one or more program modules including:
an acquiring module configured to acquire an encrypted image displayed by a paying terminal associated with a user and decrypt the encrypted image to acquire payment information, wherein the encrypted image encrypts the payment information including a payment amount and an identifier of a payment account associated with the paying terminal;
a sending module configured to send a payment request to a server, wherein the payment request includes the payment information;
a request verification module configured to display a message in response to a response from the server, the message prompting the user to provide verification information, wherein the verification information comprises biometric information of the user,
a transfer module configured to transfer the verification information provided by the user to the server, wherein the server generates processing results for the payment request when the verification information authenticates the payment request; and
a receiving module configured receive and display the processing results returned from the server.

12. The check-out terminal of claim 11, wherein:
the encrypted image is generated by the paying terminal.

13. The check-out terminal of claim 11, wherein:
the encrypted image is generated by the server and transferred to the paying terminal to be displayed.

14. The check-out terminal of claim 11, wherein:
the payment request is authenticated when the server determines that the user is authorized to access the payment account based on the biometric information.

15. The check-out terminal of claim 11, wherein the biometric information is information related to: fingerprint, iris, face features, voice print, DNA, palm print, hand geometry, retina, or odor/scent.

16. The check-out terminal of claim 11, wherein:
the biometric information is acquired by scanning a body part of the user, and the body part is selected from the group consisting of: fingerprint, iris, retina, and face.

17. The check-out terminal of claim 11, wherein:
the processing results include an approval or a denial; and
the processing results include an approval when the server determines that the payment account contains an equal or greater amount of fund compared with the payment amount.

18. The check-out terminal of claim 11, wherein:
the processing results include an approval or a denial; and
the processing results include a denial when the server determines that the payment account contains a lesser amount compared with the payment amount, or when the server determines that the user is not authorized to access the payment account.

19. The check-out terminal of claim 11, wherein:
the encrypted image is based on PDF417 code format.

20. A non-transitory computer readable storage medium having stored therein one or more instructions, which, when executed by a check-out terminal, cause the check-out terminal to:
acquire an encrypted image displayed by a paying terminal associated with a user, wherein the encrypted image encrypts payment information including a payment amount and an identifier of a payment account associated with the paying terminal, decrypt the encrypted image to acquire the payment information;
send a payment request to a server, wherein the payment request includes the payment information;
in response to a response from the server, display a message prompting the user to provide verification information, wherein the verification information comprises biometric information of the user;
transfer the verification information provided by the user to the server, wherein the server generates processing results for the payment request when the verification information authenticates the payment request; and
receive and display the processing results returned from the server.
